(19) United States
(12) Patent Application Publication
(10) Pub. No.: US 2006/0269117 A1
(43) Pub. Date: Nov. 30, 2006

(54) Method for analysis of objects in microlithography

(76) Inventors: Holger Seitz, Meiningen (DE); Roman Windpassinger, Jena (DE)

Correspondence Address: JACOBSON HOLMAN PLLC, 400 SEVENTH STREET N.W., SUITE 600, WASHINGTON, DC, 20004, US

(21) Appl. No.: 10/564,282

(22) PCT Filed: Jul. 3, 2004
(86) PCT No.: PCT/EP04/07267

§ 371 Date: Jul. 5, 2006

(30) Foreign Application Priority Data
Jul. 11, 2003 (DE) 103 32 059.8

(51) Int. Cl. G06K 9/00

(52) U.S. Cl. 382/144

(57) ABSTRACT

A method for analysis of an object in microlithography. The steps of the method include providing an aerial image measurement system (AIMS) that consists of at least two imaging steps; detecting the image output of the AIMS; and employing a correction filter to correct the detected image with respect to the transfer behavior of the second or other imaging steps. An AIMS apparatus to carry out the method is also defined.

Optical imaging systems can frequently be described as transfer chains with optical transfer behavior that is described by the transfer behavior of the individual elements. The transfer behavior manifests itself in resolution capacity and is generally described by the PSF: point spread function and/or spectrally by the OTF: optical transfer function [1-4].

Normally, the optical transfer behavior of the individual elements is largely determined by the technical limiting conditions and is variable within limits. On the other hand, generally a defined transfer behavior is required for use in measuring technology. If the given limiting conditions are too restrictive, the desired system transfer behavior can no longer be achieved to the required extent. Consequences may include low contrast and low-resolution capacity and the occurrence of imaging errors.

The basic requirement of an AIMS (aerial imaging measurement system) consists of simulating the OTF of a photolithography stepper or scanner as well as possible. A deviation of the OTF leads to errors in the measuring results and their evaluation. Usually, in this case, the first magnification stage is laid out so that its OTF simulates the stepper OTF, while the resolution capacity of the following elements is selected so that it is high enough that there will only be a negligible negative effect on the system OTF. However, in practice the technical and/or financial limiting conditions limit the correlation with the stepper OTF that can be achieved.

### LITERATURE

[1] M. Born, et al., “Principles of Optics” (Cambridge University Press, 1999)
[2] J. W. Goodmann, “Introduction to Fourier Optics” (McGraw Hill Book Co. Ltd., 2000)
[3] T. L. Williams, “The Optical Transfer Function of Imaging Systems,” Publisher: Institute of Physics (1999)
[4] G. D. Boreman “Modulation Transfer Function in Optical and Electro-Optical Systems” (Tutorial Texts in Optical Engineering, Vol. TT52), Publisher: SPIE—The International Society of Optical Engineering (2001)
[5] H. Naumann, G. Schröder, “Bauelemente der Optik [Optical Components]” (Carl Hanser Verlag, Munich, Vienna, 1992)
[6] D. Murata [Editor] “Ein Apparat zur Messung von Übertragungsfunktionen optischer Systeme [A Device for Measuring Transfer Functions of Optical Systems],” Optik 17 (1960)
[7] K.-J. Rosenbruch, K. Rosenhauer: “Messung der optischen Übertragungsfunktionen nach Amplitude und Phase mit einem halbautomatischen Analysator [Measuring Optical Transfer Functions according to Amplitude and Phase with a Semi-automatic Analysis Device],” Optik 21 (1964)
[8] A. Bigelmaier, et al. “Ein Gerät zur Messung der Übertragungsfunktionen und Spaltbilder von Photoobjectiven [A Device for Measuring the Transfer Functions and Slit Images of Photo Lenses],” Optik 26 (1967/68)
[9] E. Hecht, “Optik [Optics]” (Oldenbourg Verlag, Munich, Vienna, 2001)
[10] LaFontaine, et al., “Submicron soft X-ray fluorescence imaging,” Appl. Phys. Lett. 282 B, 1995.
[11] U.S. Pat. No. 5,498,923 March 1996, LaFontaine, et al. “Fluoresence [sic] Imaging”
[12] U.S. Pat. No. 6,002,740 December 1999 Cerrina, et al., “Method and apparatus for x-ray and extreme ultraviolet inspection of lithography masks and other objects”
   Inventive Solution:

The problem described is solved according to the invention in that the output variables of the AIMS system (aerial images) are corrected with respect to the transfer behavior in an additional processing step so that they correspond to the corrected output variables of the image of a photolithography stepper/scanner with the desired system OTF.

In particular, the following are prerequisites of the case,
that the output variable is a discrete or analog electrical signal or a corresponding digital data set (e.g., the pixel values of a CCD array detector);
that the desired transfer function (with the OTF: Gₛₒₗₗ) is already specified by at least one of the transfer elements;
that the resolution capacity of the interfering elements (G_{stör}) is higher than that of the desired corrected system.

According to the invention, the correction consists of a filtering of the output variable, at which the percentage of the interfering transfer elements in the transfer behavior is compensated. Possible technical realizations:
Electronic circuit (analog or discrete filter)
Algorithmic correction using software in a digital computer (μC, PC, DSP, etc.)
   Basic Principle:

In the following, spatially-dependent variables are indicated with lower case letters and their respective Fourier transforms with capital letters. An example that can be named here is the PSF (designation: g(x,y)) and its Fourier transform, OTF (designation (G(fₓ,f_{y})).

If the transfer behavior can be described with adequate approximation by a linear system with N elements, the OTF of the system results as a product of the OTFs of the individual transfer elements and the PSF of the system as a convolution product of the PSFs of the individual elements. Generally, it is true that the OTF is the spectrum of the PSF, i.e., its Fourier transform. Accordingly, with a two-dimensional image, the OTF of the system is:
G_{System}(fₓ,f_{y})=G₁(fₓ,f_{y})·G₂(fₓ,f_{y})· . . . ·G_{N}(fₓ,f_{y})=G_{Soll}(fₓ,f_{y})·G_{Stör}(fₓ,f_{y}) (1.1)
i.e., G_{Stör}(fₓ,f_{y})=G₂(fₓ,f_{y})· . . . ·G_{N}(fₓ,f_{y})
and/or the PSF of the system
g_{System}(x,y)=g₁(x,y)*g₂(x,y)* . . . *g_{N}(x,y)=g_{Soll}(x,y)*g_{Stör}(x,y)
i.e., g_{Stör}(x,y)=g₂(x,y)* . . . *g_{N}(x,y)
where “*” is the convolution operator. Under the condition that
G_{Stör}(fₓ,f_{y})≠0 for all (fₓ,f_{y}), in which G_{Soll}(fₓ,f_{y})≠0,
the correction filter can be specified as
G_{Filter}(fₓ,f_{y})=[G_{Stör}(fₓ,f_{y})]⁻¹ for all (fₓ,f_{y}) in which G_{Stör}(fₓ,f_{y})≠0, and
G_{Filter}(fₓ,f_{y})=c otherwise,
with c being any constant. Thus, the filtering theoretically supplies:
G_{System}(fₓ,f_{y})·G_{Filter}(fₓ,f_{y})=G_{Soll}(fₓ,f_{y})

The filtering can also be carried out as a convolution in the local area:
g_{System}(x,y)*g_{Filter}(x,y)=g_{Soll}(x,y)
with the filter function
g_{Filter}(x,y)=FT⁻¹{G_{Filter}(fₓ,f_{y})}.

FT⁻¹{ . . . } is the (inverse) Fourier transformation.

In addition to the above mentioned filter function, other functions are also conceivable that do not change the overall transfer behavior, but possibly have better properties, e.g., with respect to noise. Example:
G_{Filter}(fₓ,f_{y})=[G_{Stör}(fₓ,f_{y})]⁻¹ f for all (fₓ,f_{y}) in which G_{Soll}(fₓ,f_{y})·G_{Stör}(fₓ,f_{y})≠0,
and
G_{Filter}(fₓ,f_{y})=0 otherwise.

The procedure described applies analogously for a one-dimensional or multi-dimensional images. Besides that, it is conceivable in principle to select a spectral representation that is not based on the Fourier transformation, e.g., the Z transformation.

In actual imaging systems, the OTF varies more or less over the image area. Variations of this type can be taken into consideration approximately in that the corresponding filter functions are set up for several suitably selected partial ranges and the results of the associated filtering are superimposed with weighting.

### EMBODIMENT EXAMPLE

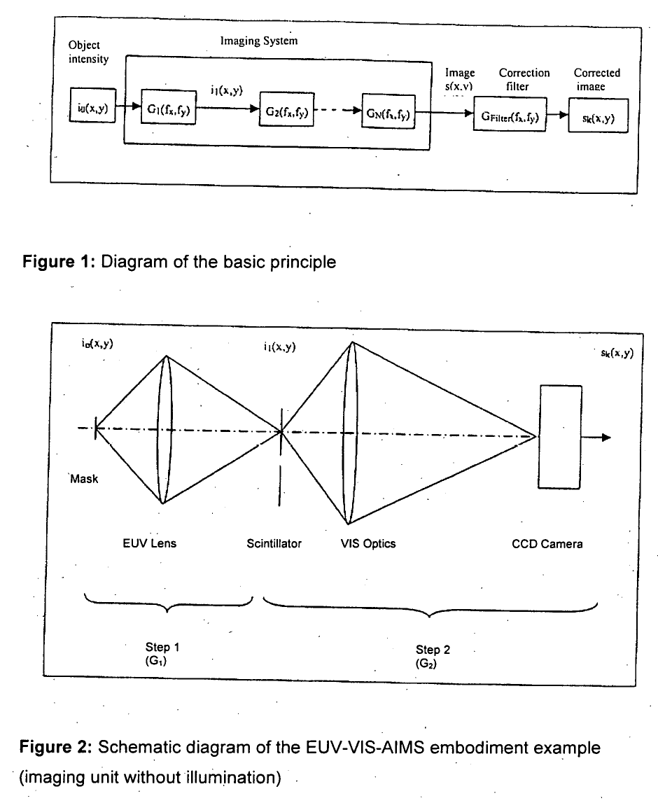

FIG. 1 shows the inventive principle schematically.

The imaging system for an object that is characterized by an object intensity iₒ (x,y) consists of N steps G₁-G_{N}, each of which is characterized by a transfer function.

The image that develops, characterized by a signal distribution s(x,y) is corrected using a correction filter, in that an involution occurs for the steps G₂-G_{N} of the imaging system.

The result is a corrected image with an image signal distribution sₖ(x,y).

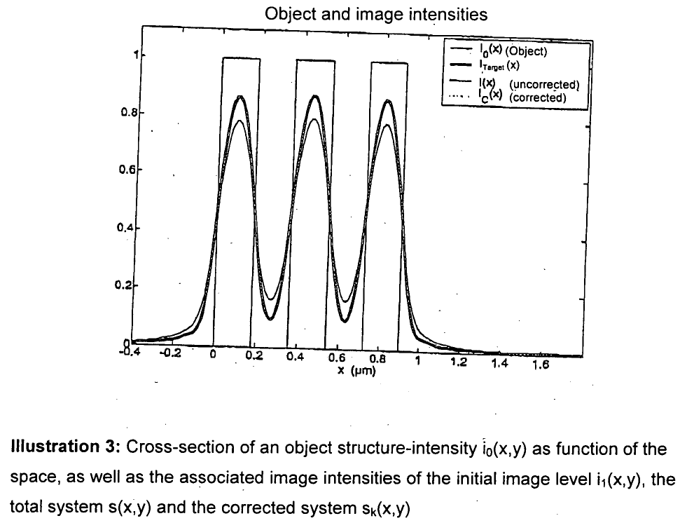

In the following, a system will be described as an embodiment example (see FIG. 2) divided into two imaging steps that correspond to the transfer functions G₁, G₂ in FIG. 1.

The imaging principle (without EUV illumination unit) of a two-step EUV-VIS-AIMS (aerial imaging measurement system) is shown for testing a mask for semiconductor manufacturing. The illumination can occur using incident light, as here with the EUV illumination, but also using transmitted light.

The object (in this case a mask structure) will be imaged on a scintillator using an EUV lens (intermediate image) that converts the EUV wave length into visible light. Using the subsequent VIS optics, the intermediate image is transferred to a CCD camera.

In it i₀(x,y): object intensity
i₁(x,y): output intensity from step 1 (intermediate image)
s(x,y): measured image signal (output variable from step 2)

In the case of the above mentioned AIMS
G_{AIMS}(fₓ,f_{y})=G_{System}(fₓ,f_{y})=G₁(fₓ,f_{y})·G₂(fₓ,f_{y})
with
G_{Soll}(fₓ,f_{y})=G₁(fₓ,f_{y})=G_{Stepper}(fₓ,f_{y}) (Step 1)
and
G_{Stör}(fₓ,f_{y})=G₂(fₓ,f_{y})
(This step 2 can be composed, e.g., of a percentage of the VIS optics and a percentage of the CCD camera).

G₁(fₓ,f_{y}) is the OTF of the first magnification step that is used to simulate the transfer behavior of a stepper. G₂(fₓ,f_{y}) combines the OTF of the following steps, e.g., remagnification step(s), image converter layers, CCD array detector, etc.

The image by step 2 can be represented by a convolution product:
s(x,y)=g₂(x,y)·i₁(x,y)

Equivalent: the image spectrum S(fₓ,f_{y}) can be represented as a product:
S(fₓ,f_{y})=G₂(fₓ,f_{y})·I₁(fₓ,f_{y})

In this, g₂(x,y) is the impulse response and G₂(fₓ,f_{y}) is the transfer function from step 2.

The resolution capacity of step 2 is greater than that of step 1.

In other words: the upper limit frequency of step 2 is greater than that of step 1.

This means |G₂(fₓ,f_{y})|>0 for all points (fₓ,f_{y}) below the upper limit frequency of step 1 (possibly with the exception of individual points (fₓ,f_{y}) in which |G₂(fₓ,f_{y})|=0 (?))

g₂(x,y) or G₂(fₓ,f_{y}) are adequately known numerically, whether by measurement or calculation on the basis of the device parameters.

According to the invention, the intensity i₁(x,y) will be reconstructed from s(x,y).

Examples for Determining the Transfer Function of Systems

Concrete computational example: for an ideal, i.e., image-error-free, incoherent image with circular aperture, the distribution of the radiation intensity in the image plane s(x,y) results by convolution of the radiation intensity distribution in the object plane i₀(x,y) and the standardized spot obliteration function gᵢ:

$${g}_{i} ( x , y ) = {[ \frac{2 \cdot {J}_{1} ( \frac{π \cdot NA \cdot r}{λ} )}{\frac{π \cdot NA \cdot r}{λ}} ]}^{2} , \\ where$$

$$r = \sqrt{{x}^{2} + {y}^{2}}$$

(NA: numerical aperture λ: wave length J₁: first-order Bessel function)

The associated OTF G1 of this ideal incoherent image,

$${G}_{i} ( {f}_{x} , {f}_{y} ) = \{ \begin{matrix}\frac{2}{π} [ arc cos ( \frac{λ \cdot ρ}{2 NA} ) - \frac{λ \cdot ρ}{2 NA} \sqrt{1 - {( \frac{λ \cdot ρ}{2 NA} )}^{2}} ] & for & \vert ρ \vert \leq 2 NA / λ \\ 0 & for & \vert ρ \vert > 2 NA / λ\end{matrix} , \\ with \\ ρ = \sqrt{{f}_{x}^{2} + {f}_{y}^{2}}$$

Thus, the correction filter of an ideal incoherent image results as
G_{Filter}(fₓ,f_{y})=[Gᵢ(fₓ,f_{y})]⁻¹ for all (fₓ, f_{y}) in which Gᵢ(fₓ,f_{y})≠0, and
G_{Filter}(fₓ,f_{y})=0 otherwise.

Image errors can be detected, e.g., by multiplication of the incoherent OTF with a phase term e^{iφ(fx,fy}.

In the literatures [3-5], calculations for other systems, e.g., the ideal incoherent image with rectangular aperture, image converter layers, CCD camera arrays, multi-channel plates, etc., are known.

Various methods were developed for measuring the transfer function, see e.g., [3-8]. It should be noted that the transfer function of a system or partial system depends e.g., on the wave length and the numerical aperture. Either the transfer function can be measured for all the system settings used or the transfer function of one (or more) system setting(s) can be extrapolated to other system settings.

Solution: Compensation of the Impulse Response g₂(x,y)

Mathematical implementation:

Compensation in the spectral range:
1. Fourier transformation: S(fₓ,f_{y})=F{s(x,y)}
2. Division by G₂(fₓ,f_{y}): S′(fₓ,f_{y})=S(fₓ,f_{y})/G₂(fₓ,f_{y})
3. Reverse transformation: sₖ(x,y)=F⁻¹ {S′(fₓ,f_{y})}

An unfolding in the local area is also possible using an iterative algorithm.

Under consideration of a magnification M at step 2, the coordinate values i₁ change to i₁′
i₂(x,y)=g₂(x,y)*i₁′(x,y), with i₁′(x,y)=i₁(x/M,y/M)
and/or
I₂(fₓ,f_{y})=G₂(fₓ,f_{y})·I₁′(fₓ,f_{y}), with I₁′(fₓ,f_{y})=|M|·I₁(M·fₓ,M·f_{y})
(Fourier Transformation)

Step 2 itself is to be seen as a combined system.

Step 2 must necessarily contain a wave-optical partial system. In the simplest case, it consists only of the detector (CCD array, or the like).

Mathematically, the imaging by step 2 behaves analogously to an incoherent optical image, in which the initial intensity occurs due to convolution of the inherent intensity with the PSF.

### EXAMPLE

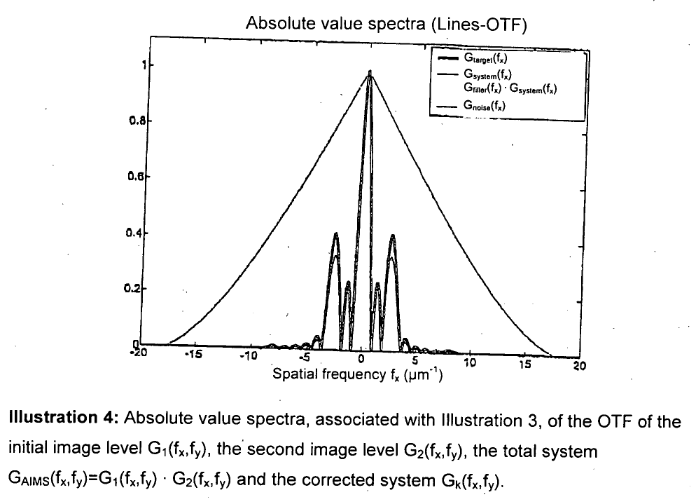

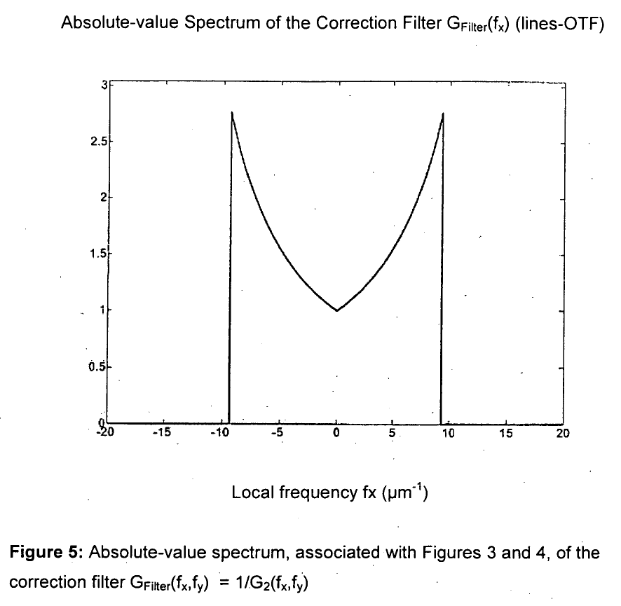

### Compensation of the Impulse Response g₂(x,y) by Correction with a Calculated Filter (See FIGS. 3-5)

FIG. 3 shows the calculated cross section of an object structure intensity i₀(x,y) (3 lines with a width in nm and distance in nm) as a function of the location, as well as the associated image intensities of the first image step i₁(x,y), of the overall system s(x,y) and of the corrected system sₖ(x,y), whereby the following image parameters were used: wave length, numerical aperture, signal. An ideal VIS lens was assumed as the interfering element (second image stage). In FIG. 4, it can be seen clearly that the intensities of the first imaging step (target) correlate very well with the intensities of the corrected system.

FIG. 4 shows the absolute-value spectra, associated with FIG. 4, of the OTF of the first imaging step G₁(fₓ,f_{y}), of the second imaging step G₂(fₓ,f_{y}), of the overall system G_{AIMS}(fₓ,f_{y})=G₁(fₓ,f_{y})•G₂(fₓ,f_{y}) and of the corrected system Gₖ(fₓ,f_{y}). It can be clearly seen here, as well, that the absolute-value spectrum of the OTF of the first imaging step (target) correlates very well with that of the corrected system.

FIG. 5 shows the absolute value spectrum, associated with FIGS. 4 and 5, of the correction filter G_{Filter}(fₓ,f_{y})=1/G₂(fₓ,f_{y}).

### ADVANTAGES OF THE INVENTION

1.) Lower resolution capacity adequate for subsequent interfering elements, e.g.,
Smaller numerical aperture of the VIS optics of the above mentioned embodiment example or
Larger wave length of the VIS optics of the above mentioned embodiment example adequate
With the EUV/VIS solution, no index adaptation between scintillator and VIS optics (see also [10+11]) is necessary in order to emulate the stepper imaging using AIMS.

2.) Simpler technical implementation and thus more cost-effective.

3.) CCD with higher pixels or binning can be used=>lower noise with shorter time=>higher throughput due to shorter illumination time

4.). Overall magnification can be selected lower=>higher throughput due to larger image field

1. Method for analysis of an object in microlithography, comprising the steps of:
providing an aerial image measurement system (AIMS) that consists of at least two imaging steps;
detecting the image output of the AIMS;
employing a correction filter to correct the detected image with respect to the transfer behavior of the second or other imaging steps.

2. The method according to claim 1, further comprising the step of illuminating the object with incident light.

3. The method according to claim 1, further comprising the step of illuminating the object with transmitted light.

4. The method according to claim 1, wherein the image output contains output variables and the correction by the correction filter is carried out in such a way that the corrected output variables of the image correspond to a photolithography stepper or scanner.

5. The method according to claim 1, whereby the correction is carried out by an involution.

6. The method according to claim 1, whereby measured correction values are used for the correction.

7. The method according to claim 1, whereby calculated correction values are used for the correction.

7. The method according to claim 1, whereby the correction is carried out using an electronic circuit by means of an analog or digital filter or an algorithmic correction by means of software in a digital computer.

8. The method according to claim 1, wherein the object is a mask for manufacturing semiconductors.

9. An apparatus for analysis of an object in microlithography, the apparatus comprising:
an aerial image measurement system (AIMS) that consists of at least first and second imaging devices;
means for detecting the image output of the AIMS; and
a correction filter for correcting the detected image with respect to the transfer behavior of all of the imaging devices other than the first imaging device.

10. The apparatus of claim 9, wherein the first imaging device is selected from the group consisting of EUV imaging optics with mirrors; EUV imaging optics with zone plates; X-ray imaging optics with mirrors;
X-ray imaging optics with zone plates and UV imaging optics with diffractive optics.

11. The apparatus of claim 9, wherein the imaging devices other than the first imaging device are selected from the group consisting of UV imaging optics with diffractive optics;
VIS imaging optics with diffractive optics;
electron microscope;
image converter;
converter of photons into electrons;
fiber optics;
camera;
micro-lens array on camera or scintillator; and
amplifier elements.
